(19) United States
(12) Patent Application Publication
(10) Pub. No.: US 2010/0161585 A1
(43) Pub. Date: Jun. 24, 2010

(54) ASYMMETRIC CLUSTER FILESYSTEM

(75) Inventors: Ki Sung JIN, Iksan-si (KR); Young Kyun KIM, Daejeon (KR); Han NAMGOONG, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/542,641

(22) Filed: Aug. 17, 2009

(30) Foreign Application Priority Data
Dec. 22, 2008 (KR) 10-2008-0131744

(51) Int. Cl. G06F 12/02; G06F 17/30; G06F 12/00

(52) U.S. Cl. 707/707; 711/E12.001; 711/E12.002; 707/E17.01; 707/E17.032; 707/E17.014

(57) ABSTRACT

Provided is a data processing method in an asymmetric cluster filesystem. Each data server pre-allocates a free data block and transmits relevant information to a metadata server. The metadata server allocates a free data block and generates metadata by using free data block information, which is received beforehand and managed, upon a user's request of data generation. Then, the data server records the data on the free data block indicated in the metadata. Accordingly, network cost and operation amount of a server decrease and the load can be fairly distributed.

### CROSS-REFERENCE TO RELATED APPLICATIONS

This application claims priority under 35 U.S.C. §119 to Korean Patent Application No. 10-2008-0131744, filed on Dec. 22, 2008, in the Korean Intellectual Property Office, the disclosure of which is incorporated herein by reference in its entirety.

### TECHNICAL FIELD

The following disclosure relates to an asymmetric cluster filesystem, and in particular, to a data processing method, which pre-allocates data blocks in the asymmetric cluster filesystem.

### BACKGROUND

Due to the rapid progress of Internet technology, multimedia data such as photographs and videos are rapidly increasing, and several to several tens of TB of data are newly generated per month in the case of large portal enterprises which provide Internet service. In an existing storage structure environment, however, it is difficult to manage the large amount of data in such a rapid changing service environment due to many limitations in regard to storage scalability and manageability.

Technology of storage systems or filesystems has been greatly improved in scalability and performance. In regard to a filesystem structure, several systems attempt to establish an asymmetric cluster filesystem (in which the input/output paths of files and the metadata management paths of the files are separated) to enhance the scalability and performance of a distributed storage system.

Such a structure allows a client system to directly access storage devices, and also increases storage scalability by avoiding bottleneck occurrence from the frequent access of files.

Enterprise-class storage solutions, for example, IBM's StorageTank, Panasas's ActiveScale Storage Cluster, Cluster Filesystems's Lustre, Hadoop's DFS and Google's Google Filesystems, have been developed based on that structure.

In a network-based distributed filesystem environment, clients, metadata servers and data servers provide the input/output of data while intercommunicating over networks.

To access a specific file, a client first obtains address information of a block (which stores the actual data of the file) from a metadata server, and accesses a data server storing the actual data on the basis of the address information to read the data of a corresponding block.

FIG. 1 is a diagram schematically illustrating the configuration of a related art asymmetric cluster filesystem.

A related art asymmetric cluster filesystem is configured with a client 101, a metadata server 103, and data servers 107a to 107c. A File is constituted from metadata 105 and data blocks 109a and 109b.

The metadata server 103 stores and manages the metadata 105 of the file. The metadata 105 includes attribute information including the size, generation time and access authority of the file and an address in which the file is stored. The actual data of the file are stored in the data blocks 109a and 109b of the data servers 107a to 107c.

The same data block can be copied to data servers which are physically separated, to provide high availability of the filesystem. When a client intends to read a file called example.txt, it requests the metadata 105 of the example.txt file to the metadata server 103, which provides the metadata 105 including the attribute and address information of the file to the client 101.

When the client 101 requests the data of the data blocks to the data servers 107a to 107c, respectively, the data servers 107a to 107c provide the data of the respective data blocks to the client 101. Since the respective data blocks requested by the client are stored in the data servers 107a to 107c, the client 101 requests the data of the data block to the nearest data server over a network and thus maximizes locality-based input/output (I/O) performance.

Even if any one of the data servers which include the data block storing pertinent data fails, high availability of the filesystem is secured because the data of a corresponding data block may be acquired from another data server that is operating normally.

FIG. 2 is a diagram illustrating a process for generating blocks in a system such as Hadoop DFS or Google Filesystem.

Referring to FIG. 2, when any one of clients 201 requests generation of a data file to a metadata server 203 in operation 207, the metadata server 203 requests a block for storing the data of a newly-generated file to a data server 205 in operation 209, receives response for the allocation of the block from the data server 205 in operation 211, and provides information of the block for newly generated data to the client 201 in operation 213. The client 201 requests generation of data to a corresponding data server on the basis of the address information of the data block, i.e., metadata.

Meanwhile, various problems occur because a client should request an allocation of a block each time a file is generated.

Since all blocks are allocated by requesting allocation to the data server 205 over a network, network communication cost is incurred each time the block is allocated, and the response time for the file generation request of the client 201 is delayed. Particularly, the resulting delay in response time further increases when a data server receiving a request is busy processing a large amount of data.

When clients' requests for file generation increase rapidly, response time for each file generation is also delayed because network access to the data server increases relatively. Domestic video service enterprises provide with simultaneous access users ranging from thousands to tens of thousands. Under theses conditions, the quality of all video service is degraded if the network cost increases.

### SUMMARY

In one general aspect of the present invention, a metadata server in an asymmetric cluster filesystem includes: a metadata management unit managing metadata; a free data block management unit managing information on at least one free data block which is received from a data server; and a controller controlling the metadata management unit and the free data block management unit, wherein, in response to a metadata generation request of a client, the controller generates a metadata file through the metadata management unit, assigns a free data block for generation storage of data through the free data block management unit, and returns metadata including information on the free data block.

The free data block management unit may manage free data block information for each data server.

The managing of free data block information for each data server in the free data block management unit may include: searching the numbers of free data blocks of each data server; selecting a data server having most free data blocks, and assigning a free data block in the selected data server for generation storage of data; and deleting the assigned free data block from the free data block information.

In another general aspect, a data server in an asymmetric cluster filesystem includes: a free data block allocator allocating at least one free data block; a free data block manager managing a list of free data blocks; and a controller controlling the free data block allocator and the free data block manager, wherein: the controller searches the number of free data blocks through the free data block manager, and when the number of free data blocks is equal to or less than a minimum reference number, the controller additionally allocates a free data block through the free data block allocator, adds information of the allocated free data block in the list of free data blocks through the free data block manager and transmits the information of the allocated free data block to a metadata server.

The free data block manager may write a free data block list storing information of a free data block when the free data block is allocated. The free data block manager may delete the free data block in which data have been generated from the free data block list when the data are generated. The free data block manager may search the number of free data blocks through the free data block list.

By transmitting the list of free data blocks managed by the free data block manager, the controller may transmit the information of the allocated free data block to the metadata server.

In another general aspect, a data processing method in an asymmetric cluster filesystem including a metadata server, a plurality of data servers, and a client includes: searching the number of free data blocks, allocating a free data block when the number of free data blocks is equal to or less than a minimum reference number, and transmitting a list of the free data blocks to the metadata server, by the data server; receiving a metadata generation request of the client and generating a metadata file by the metadata server; assigning, by the metadata server, a free data block for generation storage of data from the transmitted list of free data blocks; recording information on the assigned free data block in the metadata file, and providing the information to the client, by the metadata server; and generating data of the client in the assigned free data block based on metadata and deleting the free data block from the free data block list upon receiving a request to generation storage of new data from the client, by the data server.

In the data processing method of the asymmetric cluster filesystem, the assigning of a free data block in the metadata server may include: selecting a data server having most free data blocks, and assigning a free data block for generation storage of data in the selected data server; and deleting the assigned free data block from the free data block information.

In the data processing method of the asymmetric cluster filesystem, generating a free data block list storing information of the allocated free data block may be further included between the allocating of the free data block and the transmitting of the free data block, in the data server. In the transmitting of the free data block list, the data server may transmit the free data block list as information of the free data block. In the storing of the free data block information, the metadata server may store the free data block list as information of the free data block. In the assigning of the free data block, the metadata server may assign the free data block for generation storage of data through the free data block list.

In the data processing method of the asymmetric cluster filesystem, in the allocating of the data block/the transmitting the information, the data server may transmit a list of all free data blocks, which are currently kept in the data server, to the metadata server, and the metadata server may update a list of free data blocks, which are currently stored and managed, to the transmitted list of all free data blocks and manage the updated list.

In the data processing method of the asymmetric cluster filesystem, in the allocating of the data block/the transmitting the information, the data server may transmit only information of an additionally allocated free data block to the metadata server, and the metadata server may add the transmitted list in a list of free data blocks, which are currently stored/managed, and manage the added list.

Other features and aspects will be apparent from the following detailed description, the drawings, and the claims.

### BRIEF DESCRIPTION OF THE DRAWINGS

FIG. 1 is a diagram schematically illustrating the configuration of a related art asymmetric cluster filesystem.

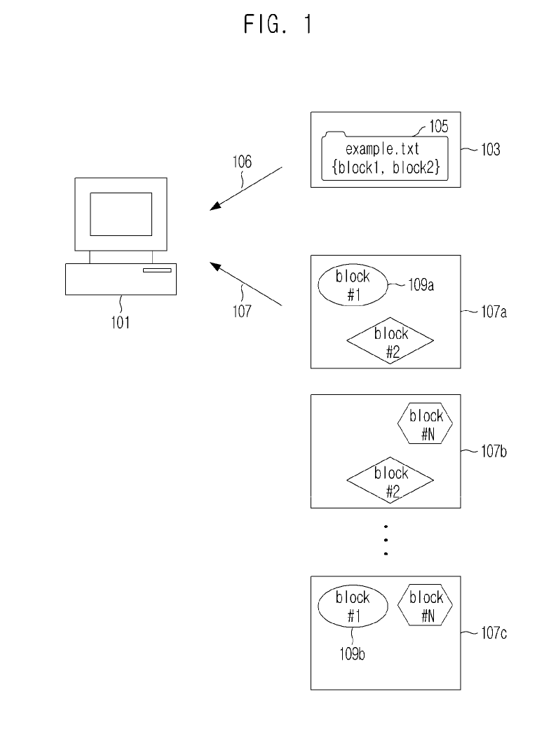

FIG. 2 is a diagram illustrating a process for generating blocks in a system such as Hadoop DFS or Google Filesystem.

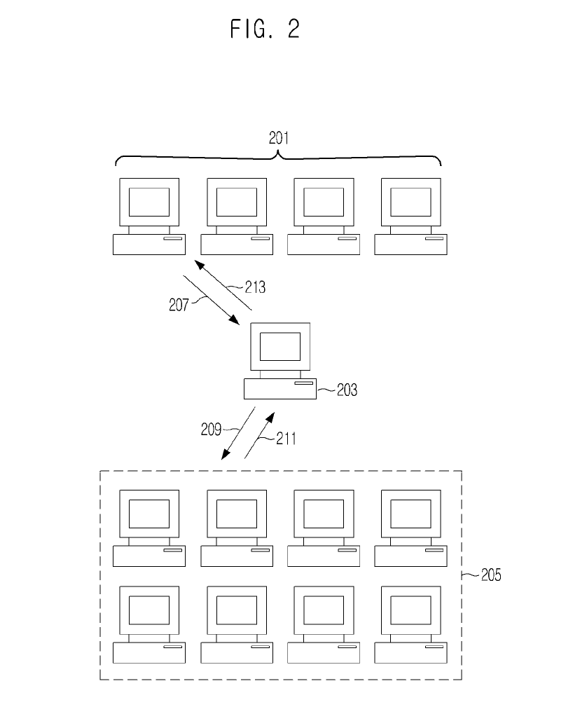

FIG. 3 is a block diagram schematically illustrating the configuration of a metadata server in an asymmetric cluster filesystem according to an exemplary embodiment of the present invention.

FIG. 4 is a flowchart schematically illustrating a process for generating metadata in the metadata server of the asymmetric cluster filesystem according to an exemplary embodiment.

FIG. 5 is a block diagram schematically illustrating the configuration of a data server in the asymmetric cluster filesystem according to an exemplary embodiment.

FIG. 6 is a flowchart schematically illustrating a metadata processing procedure in the data server of the asymmetric cluster filesystem according to an exemplary embodiment.

FIG. 7 is a flowchart schematically illustrating a data processing procedure in the asymmetric cluster filesystem according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Exemplary embodiments relate to a method and process thereof, which efficiently allocate data blocks in an asymmetric cluster filesystem that provides multiple copies. In the asymmetric cluster filesystem according to exemplary embodiments, clients, a metadata server and data servers provide the input/output of data while intercommunicating over networks. To access a specific file, the client acquires address information of a block (which stores the actual data of a file) from the metadata server, and accesses a data server including a corresponding data block to read the data of the data block on the basis of the address information.

Exemplary embodiments provide a method and process thereof, which pre-allocate and manage data blocks in the asymmetric cluster filesystem. According to a pre-allocation method for data blocks in the asymmetric cluster filesystem, a client can allocate a new free block from a pre-acquired data block region without requesting the allocation of a block to the data server when generating a file, which reduces unnecessary network costs and the response time for the client to improve whole service quality.

An asymmetric cluster filesystem according to an exemplary embodiment includes a plurality of clients, a metadata server and a plurality of data servers, which are connected over a network. Each file may be divided into a plurality of blocks, or may be stored as one file of consecutive blocks. The metadata server can be configured as a separate server, or disposed in the same physical device or machine as the data server and the client.

Hereinafter, exemplary embodiments of the present invention will be described in detail with reference to the accompanying drawings.

<Metadata Server>

A metadata server according to an exemplary embodiment provides a method which allocates free data blocks in a region that manages information of the free data blocks which have been acquired in advance from a data server without requesting the allocation of blocks to the data server, upon a metadata generation request of a client.

The free data block is a data block that has been pre-allocated to the data server, and refers to the data block which has no data recorded and is intended to be used for “generation storage” of data in future. Generation storage of data does not denote simply storing data but denotes storing pertinent data for the first time in the data server.

As described below, although a request to the allocation of data block is not received from the metadata server, the data server according to an exemplary embodiment allocates the data block as a free data block when a certain condition is satisfied and transmits relevant information to the metadata server.

Configuration of Metadata Server

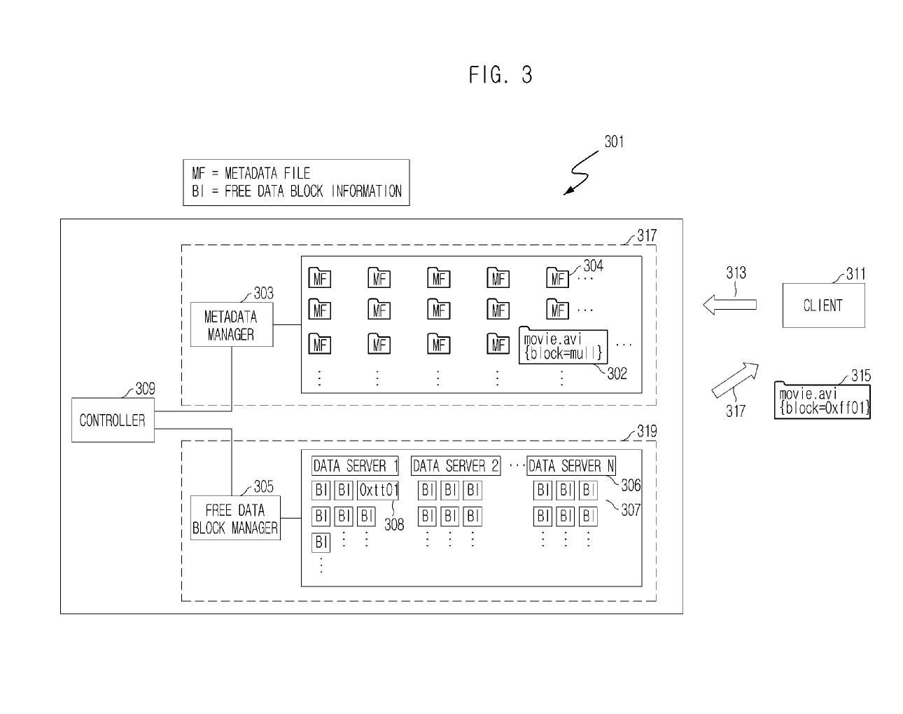

FIG. 3 is a block diagram schematically illustrating the configuration of a metadata server in an asymmetric cluster filesystem according to an exemplary embodiment.

A metadata server 301 according to an exemplary embodiment includes a metadata management unit 317, a free data block management unit 319, and a controller 309. The metadata management unit 317 manages metadata files 304 recording metadata for each data. The free data block management unit 319 manages free data blocks that are pre-allocated by data servers. The controller 309 controls a metadata manager 303 and a free data block manager 305.

The metadata management unit 317 manages a file namespace tree for the hierarchical structure of files and directories. The metadata management unit 317 stores the name, size, and access authority of the each file, and address information of blocks.

The free data block management unit 319 manages information of the free data block that exists in each of the data servers.

Free data block information 307 may be divided and managed for each data server 306, as illustrated in FIG. 3. By dividing free data block information 307 for each data server 306, various algorithms may be applied for improving performance.

For example, the data server, having a relatively few free data blocks among the data servers, is regarded that load for generation storage of data is currently concentrated, and the free data block in a data server having small load, i.e., a data server having many free data blocks is assigned preemptively to fairly distribute the total load.

The information of the free data blocks, which are managed by the free data block management unit 319 of the metadata server 301, is established by compiling information that is transmitted from data servers.

That is, the metadata server does not request the information of the free data blocks to the data servers, but the data servers voluntarily notify the metadata server of their free data block information.

In this way, the metadata server passively manages information of the free data blocks on the basis of information transmitted from the data servers without requesting information to the data servers, and thus the management costs of the free data blocks and network costs decrease greatly.

The metadata server uses the list of the free data blocks transmitted from the data server as it is to manage information of the free data blocks for each data server, which leads to decrease operation cost.

Generate Metadata

As illustrated in FIG. 3, when a client 311 requests metadata in operation 313, the metadata server 301 searches a plurality of metadata 304 in the metadata management unit 317 to determine whether corresponding metadata exist.

When the corresponding metadata exist, the metadata server 301 provides the metadata to the client 311. When the metadata do not exist, the metadata server 301 determines the metadata request of the client 311 as a request to generation storage of data, and the controller 309 generates a metadata file through the metadata manager 303. At this point, generation storage of data does not denote simply storing data but denotes storing the corresponding data for the first time in the data server.

For example, when the client 311 intends to newly generate and store a file called movie.avi in the data server, the controller 309 of the metadata server 301 generates a metadata file 302 for the movie.avi file in the metadata management unit 317. At this point, the metadata includes only attribute information including the name, access authority and generation time of the file, and does not include information of a data block for actually recording data.

Then, the controller 309 assigns any one of the free data blocks, which are managed by the free data block management unit 319, as a data block for generating and storing the movie.avi file, through the free data block manager 305. The free data block manager 305 selects a free data block for storing data from a list managing information of the free data blocks, notifies the controller 309 of a corresponding free data block, and deletes the corresponding free data block from the list.

At this point, the free data block manager 305 searches a list managing the information of the free data blocks in the free data block management unit 309. The free data block manager 305 selects a data server which is predicted as having the smallest load, i.e., currently includes the most free data blocks, and assigns a free data block in a corresponding data server.

For example, when a data server #1 is determined as a data server that currently includes the most free data blocks, the free data block manager 305 assigns any one (0ₓff01) 308 of the free data blocks in the data server 1 as a data block for generating and storing pertinent data, and removes the selected free data block 308 from the free data block list of the data server #1.

The controller 309 stores information of the newly assigned data block in the metadata file 302, and provides metadata 315 including the data block information to the client 311 in operation 317.

The client 311 may record data in the data server on the basis of the data block information included in the metadata 315.

As described above, when generating a new file, only the network communication costs between the client and the metadata server is required, and communication for requesting the data block information and responding to the request is not required between the metadata server and the data server. Moreover, when the metadata server assigns data blocks, calculation cost for block allocation is hardly required because only a task for selecting one data block from a free data block list stored in a memory is required.

Comparison Example

A process, in which the existing system such as HDFS or Google Filesystem generates and provides metadata in response to the data generation storage request of a client, briefly includes: (1) generating a metadata file for movie.avi data in the metadata server; (2) requesting allocation of a new data block to a data server, and waiting for a response to the request; (3) receiving a new block allocation request in the data server; (4) allocating a new data block and providing information of the data block to the metadata server; and (5) storing the data block information in metadata and providing the metadata to the client, in the metadata server.

In the existing system such as the HDFS or the Google Filesystem, because an operation (i.e., the operation (2)) which requests information of data blocks to the data server is an essential element for generating new metadata, network costs increase, and when requests to data block information are concentrated to one data server, bottleneck occurs and operation load increases.

Because the process or thread of a metadata server waits until response is received from a data server, response time is unnecessarily delayed.

An actual block is allocated through the storage/management module of a data server at a point when the allocation of a data block is requested (i.e., the operation (4)). At this point, user response time further increases because a physical block in a disk should be allocated for storing data.

In an exemplary embodiment, on the other hand, information of pre-allocated data blocks is received from a data server in advance and is managed in a metadata server. Therefore, the metadata server need not request information of a data block to the data server and wait response to the request when assigning the data block to generate and store a data file, or the data server need not allocate a data block each time information of a data block is requested. Accordingly, the metadata server rapidly responds to a client.

Metadata Generation Process

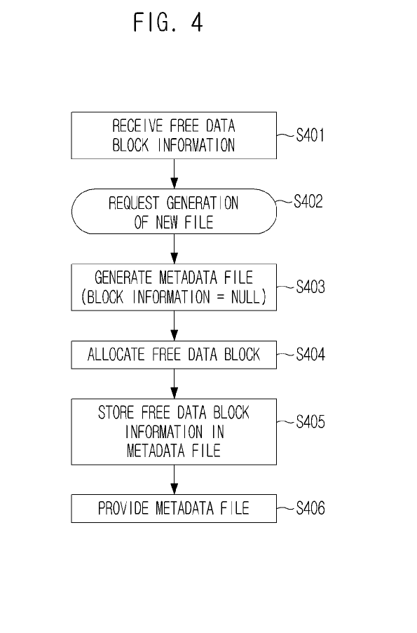

FIG. 4 is a flowchart schematically illustrating a process for generating metadata in the metadata server of the asymmetric cluster filesystem according to an exemplary embodiment.

Referring to FIG. 4, as it will be described below, the metadata server periodically or non-periodically receives information of free data blocks from the data server in step S401.

The received information of the free data blocks is managed in the free data block management unit of the metadata server. Herein, the management of the free data block information includes storage, deletion, change and adding. For example, the free data block management unit, as described below, deletes the record of a free data block (which is assigned as a data block to generate and store data) from the list of the free data blocks.

When a request to generation storage of a new data file, i.e., generation request of metadata is received from the client in step S402, the data server generates a metadata file for a corresponding data file in the metadata management unit managing metadata information in step S403.

In response to the metadata request of the client, specifically, the controller of the metadata server requests corresponding metadata to the metadata management unit that stores and manages metadata. If the metadata management unit stores and manages the corresponding metadata, it provides the metadata to the client.

When the client requests generation of metadata, i.e., when the client intends to store new data in the data server, new metadata should be generated. Then, a metadata file for a new data file is generated and the metadata are stored in the metadata management unit. At this point, the controller requests information of a data block for recording new data to the free data block management unit. because the information of a data block to record data does not exist in the metadata

In response to the request, the free data block management unit selects a free data block for storing data from the list of the free data blocks managed therein in step S404.

When the free data block management unit manages the information of the free data blocks for each data server, it selects one data server from a data server list that is managed, and assigns a free data block to be used as a data block among the free data blocks of the corresponding data server. At this point, the free data block management unit selects a data server including the most free data blocks, and thus prevents load from being concentrated to a specific data server.

When a free data block to be used as a data block is selected, the free data block management unit notifies the controller of information of a corresponding free data block and removes the corresponding free data block from the list of the free data blocks.

The controller stores the notified information of the free data blocks in a metadata file in step S405, and transmits metadata to the client in step S406.

<Data Server>

The data server of the asymmetric cluster filesystem according to an exemplary embodiment does not allocate a data block or transmit relevant information to the metadata server upon a request of data block information from the metadata server, but it allocates a predetermined number of data blocks under a predetermined condition and transmits relevant information to the metadata server.

Configuration of Data Server

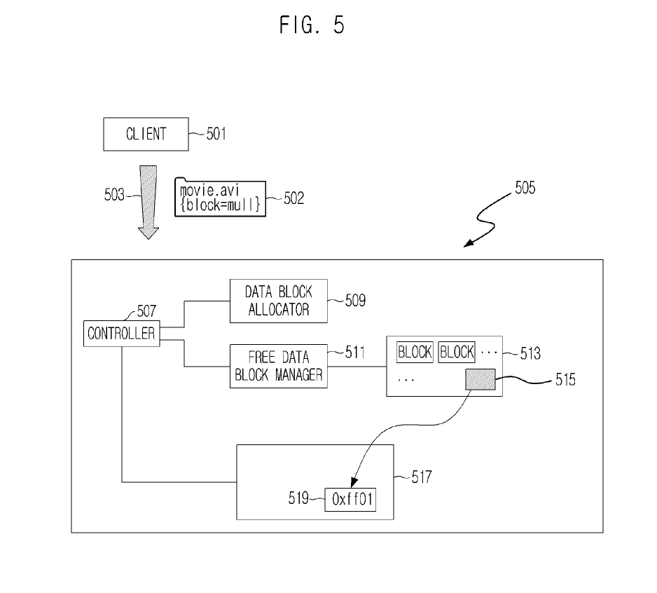

FIG. 5 is a block diagram schematically illustrating the configuration of a data server in the asymmetric cluster filesystem according to an exemplary embodiment.

Referring to FIG. 5, the data server 505 includes a data block allocator 509, a free data block manager 511, a controller 507, and a data storage 517. The controller 507 controls the data block allocator 509 and the free data block manager 511.

The data server 505 does not receive a request for information of data blocks from the metadata server to allocate the data blocks but allocates the data blocks under a predetermined condition.

When a request to generation storage of data 502 is received from the client 511 in operation 503, the controller 507 checks metadata for the data 502. At this point, generation storage of data does not denote simply storing data but denotes storing pertinent data for the first time in the data server, i.e., storing data for the first time in a corresponding data block.

Since a free data block, which assigned by the metadata server on the basis of free data block information in which the data server 505 pre-allocated and transmitted to the metadata server, is assigned and recorded in the data 502 under request to generation storage, the data server 505 generates and stores data in the corresponding free data block 519 and then removes the free data block 515 from a free data block list through the free data block manager 511.

When the number of free data blocks decreases by generating and storing data in the free data block and thus the number of remaining free data blocks becomes less than a predetermined minimum number, the data server 505 newly allocates free data blocks through the data block allocator 509, and relevant information is managed through the free data block manager 511. Moreover, information on the newly allocated free data blocks is transmitted to the metadata server.

At this point, the management of the free data block information includes adding, storage, change, and deletion based on data generation storage of a corresponding free data block.

In transmission of the free data block information, only information on the newly allocated free data blocks can be transmitted. Then, the data server 505 allows the metadata server to add corresponding data. Or, all information on current free data blocks can be transmitted for the metadata server to change the whole information on the free data blocks into corresponding information.

The free data block manager 511 also writes a free data block list. The free data block manager 511 may add, delete, or search the free data blocks using the free data block list. The free data block manager 511 may also use the free data block list in transmitting information to the metadata server.

The information or list of the allocated free data blocks is not removed after it is transmitted to the metadata server but is actually removed when data are generated and stored in response to the generation storage request of the client.

Each data server allocates a new free data block only when necessary, thereby minimizing system load for allocating data blocks.

Data Processing Procedure

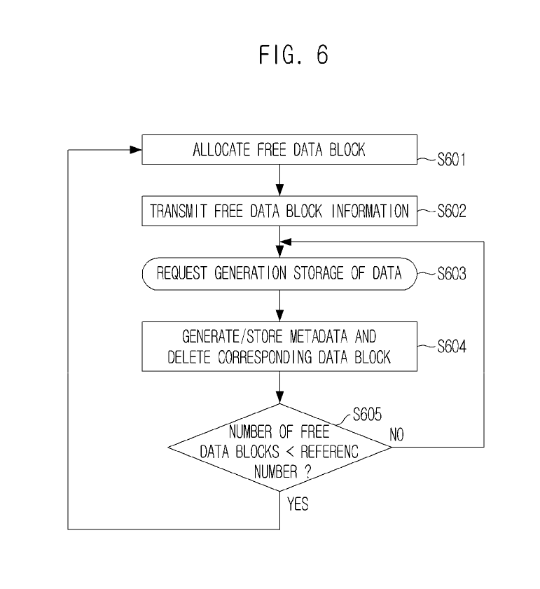

FIG. 6 is a flowchart schematically illustrating a metadata processing procedure in the data server of the asymmetric cluster filesystem according to an exemplary embodiment.

The data server allocates free data blocks, and transmits information of the allocated free data blocks to the metadata server in advance, in respective steps S601 and S602. When the data server receives a request for generation storage of data from the client in step S603, it generates and stores data in an assigned free data block based on metadata for corresponding data, and deletes a corresponding free data block from the list of the free data blocks through the free data block manager in step S604.

The data server determines whether the data record request of the client is request to generation storage of data. When the determination result shows that the data record request of the client is a request to generation storage of data, the data server generates and stores data in a free data block, and deletes a corresponding free data block from the list of the free data blocks. Through these, the number of free data blocks that are used for generation storage of data or the number of remaining free data blocks can be checked.

When the data record request of the client is received, the data server determines whether corresponding data record request is request to generation storage of data in step S603. When the determination result shows that a corresponding data record request is a request to generation storage of data, the following procedures are performed. When the determination result shows that a corresponding data record request is not a request to generation storage of data, the data server records data in an assigned data block based on the data block information of corresponding metadata and provides the record result to the client.

In more detail, the data server performs the following procedures in response to the data storage request of the client. When the client requests the record of data, the data server checks whether the record request is the first record request to a data block associated with the record request. At this point, when the size of data recorded in a corresponding data block is 0 byte, the data server determines the record request as the first record request to the data block.

When the record request is not the first record request, the data server records data in a corresponding data block and provides the record result to the client. If it is the case, the size of data recorded in the corresponding data block exceeds 0 byte, and also the data block has been already removed from the list managing the free data blocks from the previous procedure of recording data. To determine whether the record request is the first record request, the data server may check whether a corresponding data block is in the list of the free data blocks, instead of checking the size of the corresponding data block.

When the data record request of the client is the first record request, i.e., when the size of data recorded in a corresponding data block is 0 or the corresponding data block is in the list of the free data blocks, the data server generates and stores data in a free data block that is assigned in metadata for corresponding data, provides the generation storage result to the client, and removes a corresponding free data block from the list of the free data blocks.

The controller of the data server checks whether the number of remaining free data blocks, which are not used for generation storage of data, is less than a predetermined minimum reference number in step S605.

When the check result shows that the number of remaining free data blocks is more than the predetermined minimum reference number (i.e., when NO in step S605), the data server waits until the new data generation request of the client is received, and proceeds to step S603.

When the check result shows that the number of remaining free data blocks is less than the predetermined minimum reference number (i.e., when YES in step S605), it proceeds to step S601 for the data server to allocate a free data block again.

More specifically, when the number of free data blocks is equal to or less than a minimum reference value, the controller drives the data block allocator to allocate new free data blocks from a storage space, and manages information of the newly allocated free data blocks through the free data block manager.

At this point, the number of allocated free data blocks may be set as the difference between the maximum management number of free data blocks and the number of the current free data blocks to be adjusted relatively, according to the conditions of a system. Or, the number of allocated free data blocks may be set to be constant, in order to allocate a certain number of free data blocks all the time.

The free data block manager may generate a separate management list for generated free data blocks. The free data block manager may generate a new list for all the free data blocks, or may add new information in an existing list. The information of free data blocks that are generated and allocated in the data block manager is transmitted to the metadata server.

<Asymmetric Cluster Filesystem>

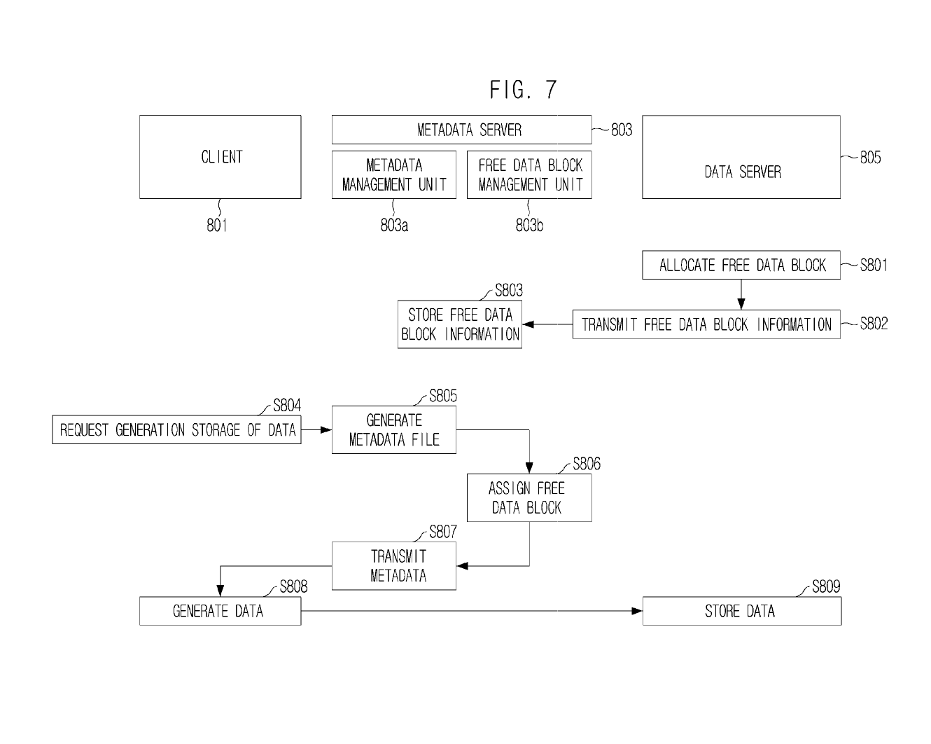

FIG. 7 is a flowchart schematically illustrating a data processing procedure in the asymmetric cluster filesystem according to an exemplary embodiment.

A data server 805 allocates a free data block in operation S801. The data server 805 stores the information of the allocated free data block and transmits the free data block information to a metadata server 803 in operation S802.

As described above, the asymmetric cluster filesystem checks the number of remaining free data blocks. When the number of remaining free data blocks is less than a minimum reference number, a free data block is additionally allocated.

The metadata server 803 stores the transmitted free data block information in a free data block management unit 803b and manages the information in operation S803.

When a request to generation storage of data is received from a client 801 in operation S804, the metadata server 803 generates a metadata file in a metadata management unit 803a in operation S805. In can be determined by checking whether metadata corresponding to the metadata management unit 803a of the metadata server 803 exist already, if the data record request of the client 801 is a request to generation storage of data. When the data record request of the client 801 is not a request to generation storage of data, the metadata server returns corresponding metadata.

After generating the metadata file in operation S805, the metadata server 803 assigns a free data block to be used for generation storage of data in the list of free data blocks that it manages, through the free data block management unit 803b in operation S806. The metadata server 803 stores metadata including the information of corresponding free data blocks and transmits the free data block information to the client 801 in operation S807.

When the client 801 requests generation storage of data to the data server 805 in operation S808, the data server 805 stores corresponding data in a free data block that metadata indicates, and deletes corresponding free data block from the list of the free data blocks in operation S809.

To the data record request of the client 801, the data server 805 determines the record request of data as the generation storage request of data when the size of a corresponding data block, i.e., the size of data that are stored in the corresponding data block is 0, or when the corresponding data block is in the list of the free data blocks.

The data server 805 checks the number of remaining free data blocks, and when the number of remaining free data blocks is less than a minimum reference umber, the data server 805 additionally allocates a free data block in operation S801.

Checking the number of free data blocks for the additional allocation of the free data block may be performed immediately after generation storage of data, or may be performed periodically at a predetermined time.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A metadata server in an asymmetric cluster filesystem, the metadata server comprising:
a metadata management unit managing metadata;
a free data block management unit managing information on at least one free data block which is received from a data server; and
a controller controlling the metadata management unit and the free data block management unit,
wherein, in response to a metadata generation request of a client, the controller generates a metadata file through the metadata management unit, assigns a free data block for generation storage of data through the free data block management unit, and returns metadata including information on the free data block.

2. The metadata server of claim 1, wherein the free data block management unit manages free data block information for each data server.

3. The metadata server of claim 2, wherein the managing of free data block information for each data server comprises:
searching numbers of free data blocks of each data server;
selecting a data server having most free data blocks, and assigning a free data block in the selected data server for generation storage of data; and
deleting the assigned free data block from the free data block information.

4. A data server in an asymmetric cluster filesystem, the data server comprising:
a free data block allocator allocating at least one free data block;
a free data block manager managing a list of the free data blocks; and
a controller controlling the free data block allocator and the free data block manager,
wherein:
the controller searches number of free data blocks through the free data block manager, and when the number of free data blocks is equal to or less than a minimum reference number, the controller additionally allocates a free data block through the free data block allocator,
the controller adds information of the allocated free data block in the list of free data blocks, through the free data block manager, and
the controller transmits the information on the allocated free data block to a metadata server.

5. The data server of claim 4, wherein, in response to a data record request of a client, when the data record request is the first record request to a data block assigned by metadata, the controller stores data in the data block and deletes a corresponding data block from the list of free data blocks through the free data block manager.

6. The data server of claim 5, wherein the controller determines the data record request as the first record request to a corresponding data block, when a size of data, which are recorded in the data block assigned by the metadata to the data record request, is 0 byte.

7. The data server of claim 5, wherein the controller determines the data record request as the first record request to a corresponding data block, when the data block, which is assigned by the metadata to the data record request, exists in the list of free data blocks managed by the free data block management unit.

8. The data server of claim 4, wherein the controller transmits the information on the allocated free data block to the metadata server by transmitting the list of free data blocks managed by the free data block management unit.

9. The data server of claim 4, wherein the controller transmits the information on the additionally allocated free data block to the metadata server.

10. A data processing method in an asymmetric cluster filesystem including a metadata server, a plurality of data servers, and a client, the data processing method comprising:
searching number of free data blocks, allocating a free data block when the number of the free data blocks is equal to or less than a minimum reference number, and transmitting a list of the free data blocks to the metadata server, by the data server;
receiving a metadata generation request of the client and generating a metadata file, by the metadata server;
assigning, by the metadata server, a free data block for generation storage of data from the transmitted list of the free data blocks;
recording information on the assigned free data block in the metadata file, and providing the information to the client, by the metadata server; and
generating data of the client in the assigned free data block based on metadata and deleting the free data block from the free data block list upon receiving a request to generation storage of new data from the client, by the data server.

11. The data processing method of claim 10, wherein the assigning of a free data block comprises:
selecting a data server having most free data blocks, and assigning a free data block for generation storage of data in the selected data server; and
deleting the assigned free data block from the free data block information.

12. The data processing method of claim 10, wherein the data server determines the data record request as a request to generation storage of new data, when a size of data, which are recorded in the data block which is assigned by the metadata to the data record request of the client, is 0 byte.

13. The data processing method of claim 10, wherein the data server determines the data record request as a request to generation storage of new data, when the data block, which is assigned by the metadata to the data record request of the client, exists in the list of the free data blocks.

14. The data processing method of claim 10, wherein the allocating of a free data block and the transmitting of a list comprise:
transmitting, by the data server, a list of all free data blocks, which are currently kept in the data server, to the metadata server; and
updating, by the metadata server, a list of free data blocks, which are currently stored and managed in the metadata server, to the transmitted list of all free data blocks.

15. The data processing method of claim 10, wherein the allocating of a free data block and the transmitting of a list comprise:
transmitting, by the data server, information on an additionally allocated free data block to the metadata server; and
updating, by the metadata server, a list of free data blocks, which are currently stored and managed, on the basis of the transmitted information.
